(19) United States
(12) Patent Application Publication
(10) Pub. No.: US 2026/0221024 A1
(43) Pub. Date: Jul. 30, 2026

(54) METHOD AND APPARATUS FOR MONITORING PORTABLE ARTICLES

(71) Applicant: SE-KURE CONTROLS, INC., Franklin Park, IL (US)

(72) Inventors: David M. Adams, Stone Park, IL (US); Elias Morales, Chicago, IL (US)

(21) Appl. No.: 19/406,115

(22) Filed: Dec. 2, 2025

Related U.S. Application Data
(60) Provisional application No. 63/750,533, filed on Jan. 28, 2025.

(51) Int. Cl. G08B 29/14

(52) U.S. Cl. CPC G08B 29/14

(57) ABSTRACT

An alarm monitoring system comprises a plurality of alarm units, each alarm unit comprising a housing having a plurality of sensor ports, each for connection to a sensor for sensing a breach of a portable article, a power input, and first and second communication ports. A programmed controller circuit is connected to the sensor ports. A communications circuit is connected between the programmed controller circuit and the first and second communication ports. A power supply is connected to the power input for powering the alarm unit, and the power input is connected to the first and second communication ports. The programmed control circuit includes an alarm function driven to generate a detectable signal as an incident of a system breach. A power adapter is operatively connected to the power input for one of the alarm units. One or more cables connect one of the first and second communication ports of one of the alarm units to one of the first and second communication ports for another one of the alarm units to power all of the alarm units from the power adapter and to communicate data between the plural alarm units. The plural alarm units are programmed to generate the detectable signal responsive to a system breach detected by any of the plural alarm units.

### BACKGROUND OF THE INVENTION

### Cross-Reference to Related Applications

This is a non-provisional application claiming priority to U.S. Provisional Application No. 63/750,533 filed Jan. 28, 2025.

### FIELD OF THE INVENTION

This invention relates to portable consumer articles and, more particularly, to a monitoring system for the articles that comprises a centralized alarm system using plural series connected distributed alarm units.1

### BACKGROUND ART

A multitude of monitoring/security systems have been devised to limit unauthorized handling and theft of portable articles. The theft problem is particularly prevalent in consumer electronics stores where expensive consumer articles such as cell phones, and the like, are displayed in large numbers and handled by many shoppers contemplating purchase.

The monitoring systems that have been devised vary widely in terms of construction, how they operate, and the particular breaches that they are designed to detect.

Typically, regardless of the precise construction of the monitoring system, it is configured to have an armed state and an unarmed state. In the unarmed state, the system can be set up to monitor one or more articles, as at a particular display location. Once the desired articles have been integrated into the monitoring system, the system can be placed in the armed state, as a result of which the designed-for system breach will cause generation of a signal that is detectable by itself and/or sent to another device or location for processing. By disarming a system, previously monitored articles may be handled and moved about without restriction. A disarmed system might be changed by being connected to another article, reconfigured, reprogramed, etc.

Various actuators have been devised to facilitate the changing of the state of such systems by only authorized personnel. Currently, systems use keys, RFID, I-buttons, keypads, etc. Most of these systems require a user to carry or obtain a separate, commonly dedicated, device to be used when the system is armed and/or disarmed.

An exemplary alarm system includes a plurality of separate alarm units. Each alarm unit may include a plurality of sensor ports for connecting to a plurality of sensors. Each sensor is adapted to monitor a distinct article. Each alarm unit includes a dedicated power supply circuit and a controller circuit for monitoring the associated sensors. If any of the associated sensors are tampered with, then the particular alarm unit will generate a visual and/or audible signal.

With such an exemplary alarm system each alarm unit operates independently and requires its own power source. Thus, a system comprising four alarm units requires four power sources. Also, there is no centralized or common alarm indication. The alarm signal is only generated at the local alarm unit where the tampering is detected. Likewise, each individual alarm unit must be armed and/or disarmed independently of the others.

### SUMMARY OF THE INVENTION

In one form, the invention is directed to the combination of a portable article and a system for monitoring the portable article. The monitoring system has an armed state and an unarmed state. The monitoring system in the armed state is configured to generate a signal as an incident of a system breach. The monitoring system includes plural alarm units each comprising a controller operatively connected to a plurality of sensor ports and to communication ports. Each of the plural alarm units comprises a power circuit connected to the communication ports. A power source is connected to one of the plural alarm units. A cable is connected between each of the plural alarm units to provide centralized power and communications for the monitoring system.

In one aspect, the alarm monitoring system comprises a plurality of alarm units, each alarm unit comprising a housing having a plurality of sensor ports, each for connection to a sensor for sensing a breach of a portable article, a power input, and first and second communication ports. A programmed controller circuit is connected to the sensor ports. A communications circuit is connected between the programmed controller circuit and the first and second communication ports. A power supply is connected to the power input for powering the alarm unit, and the power input is connected to the first and second communication ports. The programmed control circuit includes an alarm function driven to generate a detectable signal as an incident of a system breach. A power adapter is operatively connected to the power input for one of the alarm units. One or more cables connect one of the first and second communication ports of one of the alarm units to one of the first and second communication ports for another one of the alarm units to power all of the alarm units from the power adapter and to communicate data between the plural alarm units. The plural alarm units are programmed to generate the detectable signal responsive to a system breach detected by any of the plural alarm units.

In accordance with another aspect, an alarm monitoring system comprises first and second alarm units, each comprising a housing having a plurality of sensor ports, each for connection to a sensor for sensing a breach of a portable article, a power input, first and second communication ports, a programmed controller circuit connected to the sensor ports, a communications circuit connected between the programmed controller circuit and the first and second communication ports, a power supply connected to the power input for powering the alarm unit, and the power input being connected to the first and second communication ports, and the programmed control circuit includes an alarm function to generate a detectable signal detectable signal as an incident of a system breach. A power adapter is operatively connected to the power input for the first alarm unit. A plurality of one or more cables connect one of the first and second communication ports of the first alarm unit to one of the first and second communication ports for the second alarm unit to power both of the alarm units from the power adapter and to communicate data between the alarm units, wherein the first and second alarm units are programmed to generate the detectable signal responsive to a system breach detected by either of the alarm units.

In accordance with a further aspect, an alarm monitoring system comprises a plurality of alarm units. Each alarm unit comprises a housing having a plurality of sensor ports, each for connection to a sensor for sensing a breach of a portable article, a power input, first and second communication ports, a programmed controller circuit connected to the sensor ports, a communications circuit connected between the programmed controller circuit and the first and second communication ports, a power supply connected to the power input for powering the alarm unit, and the power input being connected to the first and second communication ports, and the programmed control circuit includes an alarm function to generate a detectable signal detectable signal as an incident of a system breach. A power adapter is operatively connected to the power input for one of the alarm units. A plurality of cables connect the plural alarm units in series, each cable for connecting one of the first and second communication ports of one of the alarm units to one of the first and second communication ports for another one of the alarm units to power all of the alarm units from the power adapter and to communicate data between the plural alarm units, wherein the plural alarm units are programmed to generate the detectable signal responsive to a system breach detected by any of the plural alarm units.

Further features and advantages are discussed below.

### BRIEF DESCRIPTION OF THE DRAWINGS

FIG. 1 is a block diagram representation of a monitoring system for portable articles in accordance with the invention;

FIG. 2 is a perspective view of an alarm unit used with the monitoring system in accordance with the invention; and

FIG. 3 is a block diagram representation of circuitry of the alarm unit.

### DETAILED DESCRIPTION OF THE PREFERRED EMBODIMENT

As described herein, an alarm monitoring system comprises a plurality of distinct alarm units interconnected in series using cables which carry both power and data to provide a centralized system. In an exemplary system the alarm units comprise either six or twelve alarm ports, each for connection to a sensor. This provides options for different port configurations. Communications and Power are provided for multiple alarm units with control from one alarm unit. This provides centralized control for up to forty-eight ports. The system may use smart key arming as a convenient and secure arming method, and includes arming and disarming of the system from any connected alarm unit. The connection ports allow for system expansion. The system operates with rechargeable/replaceable battery back-up which ensures the system remains operational during power outages. The monitoring uses dual sensor signal checks which enhances reliability by using two sensor scans to verify signals. The system includes audio level control by adjusting the volume of alarm sounds and includes an option to connect an external horn. The system operates with existing sensors and remote modules for compatibility with older sensors and modules. The monitoring includes alerts for low battery status and alerts for no battery status. The system provides an automatic arming feature for legacy remote modules and detects if communications are removed. Also, the system provides a notification if a key is left in the system.

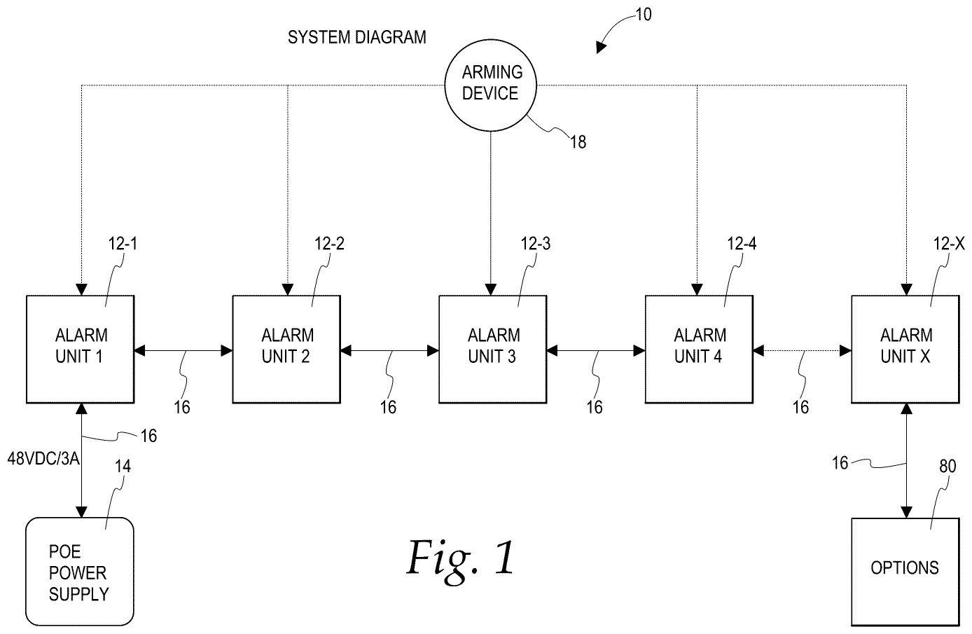

In FIG. 1, one form of the invention is depicted in block diagram form. An alarm monitoring system 10 comprises a plurality of series connected alarm units 12. Each alarm unit 12 is of identical construction and are referenced generically with reference numeral 12. In FIG. 1 each is illustrated with a suffix representing the number of the alarm unit in the system, such as 12-1, 12-2, up to 12-X. In an exemplary embodiment the alarm monitoring system 10 can include up to eight alarm units 12. As described in detail below, each alarm unit 12 has a plurality of sensor ports, each for connection to a sensor for sensing a breach of a portable article, a power input, first and second communication ports, a programmed controller circuit connected to the sensor ports, and a communications circuit connected between the programmed controller circuit and the first and second communication ports. A single POE power supply 14 is connected to the first alarm unit 12-1 for powering the monitoring system 10 eliminating the need for separate power supplies and outlets. A cable 16 is connected between adjacent pairs of alarm units 12 in the series, such as between 12-1 and 12-2, between 12-2 and 12-3, etc. The cables 16 carry power to power all of the alarm units 12 from the power supply 14 and to communicate data between the plural alarm units 12. A conventional arming device 18 may be used to interact with any of the alarm units 12 to selectively arm or disarm the system 10.

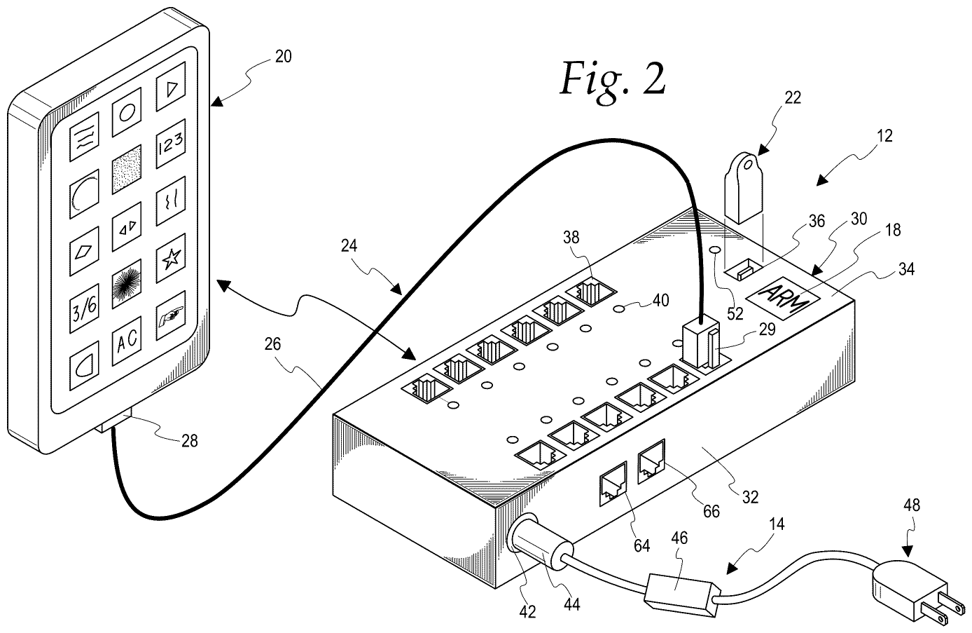

FIG. 2 illustrates an exemplary alarm unit 12 for monitoring a portable article 20 in the form of a mobile phone and optionally using an electronic key 22 for changing system operation, as discussed below.

A sensor 24 comprises a cable 26 connected to a sensing device 28 operatively attached to the portable article 20. The cable 26 terminates in a conventional modular plug 29. The alarm unit 12 determines if the sensing device 28 is attached to the portable article 20, as is well known. The portable article 20 may be of any design and the sensor 24 may comprise most known sensor types.

The alarm unit 12 comprises a housing 30 of parallelepiped construction including a base 32 and a removable cover 34. The cover 34 includes an input port 36 for receiving the electronic key 22.

The illustrated housing 30 supports twelve alarm receptacle ports 38. Each alarm receptacle port 38 comprises a conventional modular receptacle for receiving a sensor plug 29. As will be apparent, other types of receptacles can be used depending on connectors used on the sensor 24. An LED indicator 40 is provided with each receptacle port 38. In an exemplary embodiment of the invention the housing 30 includes six or twelve alarm receptacle ports 38. Different numbers of ports can be used, as will be apparent.

A power receptacle 42 in the housing 30 is connected to the power supply 14 in the embodiment of FIG. 2. As described, only one of the alarm units 12 connects directly to the power supply 14. The power supply 14 comprises a barrel jack connector 44 that receives DC power from an AC/DC adaptor 46 which is in turn connected to a plug 48 for connection to an AC electrical power source.

The housing also comprises an input, represented by an ARM block, representing the arming device 18. The arming device 18 may conventionally comprise a physical key, a system keypad, an RFID device or the like, as is well known. Alternatively, the smart key 22 may be used. The smart key may be as described in pending application 63/706,940, filed Oct. 14, 2024, the specification of which is incorporated by reference herein. A status LED 52 is used to indicate system status.

To change the state of the monitoring system 10, the electronic key 22 is inserted in the input port 36, or the conventional arming device 18 is used. After determining that the arming device 18 or 22 is an authorized device, as necessary or desired, the monitoring system 10 is enabled to selectively reprogram the monitoring system 10 or to change the monitoring system 10 from the armed state into the unarmed state or to change the monitoring system from the unarmed state into the armed state. Such reprogramming may comprise reconfiguring the setup of the alarm system, updating software programming of the system, or the like, as will be apparent.

The portable article 20 may be any type of article, typically of the type displayed in retail establishments for inspection or purchase on site. The article may range from an article of clothing to an expensive or complicated electronic article. As one example, the portable article 20 may be a mobile smart device.

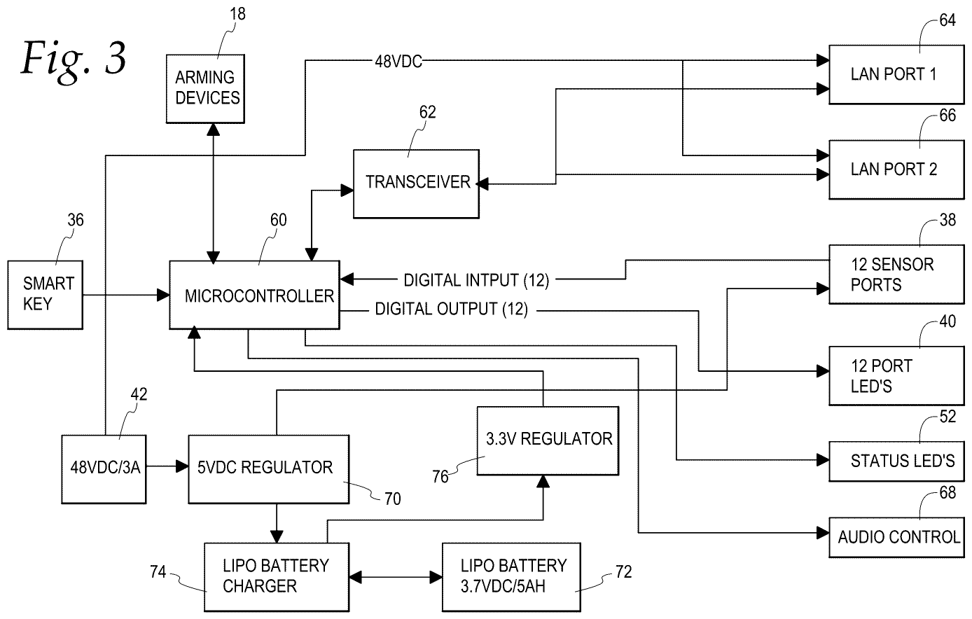

Referring to FIG. 3, a block diagram for circuitry of the alarm unit 12 is illustrated. Overall control is implemented by a programmed microcontroller 60. The microcontroller 60 may comprise a PIC32CK GC microcontroller. The PIC32CK GC offers a large memory capacity with 2 MB of Dual Panel Flash and 512 KB of SRAM. The PIC32CK GC devices have connectivity options including 10/100 Ethernet. In the exemplary embodiment, the monitoring system 10 uses data communications over the cables 16, which also carry 48 V DC power.

The microcontroller 10 is connected to the smart key port 36 and the arming device 18, as well as a communications controller in the form of a transceiver 62. The communications controller 62 is connected to first and second communication ports 64 and 66 provided on the housing 30, see FIG. 2.

The microcontroller 60 has twelve digital inputs connected to the twelve sensor ports 38, and twelve digital outputs connected to the sensor LEDs 40. The microcontroller 60 is also connected to the status LED 52 and to an audio control 68 for emitting audio sounds.

The DC input port 42 receives 48 VDC power. This is connected to a 5 VDC regulator 70. The DC input port 42 is also connected to the first and second communication ports 64 and 66. The 5 VDC regulator 70 is connected to the sensor ports 38 for use in determining sensor status. This may also be used to provide power to the sensor for use with an active sensor. A rechargeable LIPO battery 72 is connected to a battery charger 74 which is powered by the 5 VDC regulator 70. The battery charger 74 outputs 3.7 VDC power to a 3.3V regulator 76 which powers the microcontroller 60 and associated circuitry.

Each alarm unit 12 connects to one or more sensors 24, each for sensing a breach of a portable article. The programmed microcontroller 60 is programmed to generate a detectable signal as an incident of a system breach, such as the sensor LEDs 40 and the audio control 68, which may comprise a horn.

The power supply 14 is operatively connected to the power input port 42 for one of the alarm units 12. The cables 16 connect one of the first and second communication ports 64 and 66 of one of the alarm units 12 to one of the first and second communication ports 64 and 66 for another one of the alarm units 12 to power all of the alarm units 12 from the power supply 14 and to communicate data between the plural alarm units 12. The plural alarm units 12 are programmed to generate the detectable signal responsive to a system breach detected by any of the plural alarm units 12.

As is apparent, the first and last alarm units 12 in the system will use only one of the first and second communication ports 64 and 66. An internal switch may be used to provide an end point termination in the series for these alarm units. Also, the last in the series may be connected to an options block 80 for connection to optional peripheral devices, such as cloud communications or the like, as is necessary or desired. This could also be used to add NFC communications for interconnecting with smart phones.

The microcontroller 60 is programmed to perform conventional alarming functions, as is known. The programming also transfers alarm status information to other alarm units in the system so that a breach can be indicated at each alarm unit 12. The microcontroller 60 is programmed to perform a dual sensor check to avoid false alarms. If a breach is detected, then after a select delay, the sensor at issue is rechecked. If the breach persists, then an alarm condition is indicated.

The system 10 as described allows up to eight alarm units 12 to be powered from a single power source. Power and communications are serially provided over a communications cable between alarm units. This also allows the system to be armed and/or disarmed from any of the alarm units 12, and a breach detected by any alarm unit 12 is indicated at all alarm units. The status LED 52 may comprise a four color LED and can be used to indicate various conditions, such as alarm condition, arming status, low battery or no battery. An audio or visual indication may also be used to indicate if a key is left in the system.

The foregoing disclosure of specific embodiments is intended to be illustrative of the broad concepts comprehended by the invention.

1. An alarm monitoring system comprising:
a plurality of alarm units, each alarm unit comprising a housing having a plurality of sensor ports, each for connection to a sensor for sensing a breach of a portable article, a power input, first and second communication ports, a programmed controller circuit connected to the sensor ports, a communications circuit connected between the programmed controller circuit and the first and second communication ports, a power supply connected to the power input for powering the alarm unit, and the power input being connected to the first and second communication ports, and the programmed control circuit includes an alarm function to generate a detectable signal detectable signal as an incident of a system breach;
a power adapter operatively connected to the power input for one of the alarm units; and
one or more cables connecting one of the first and second communication ports of one of the alarm units to one of the first and second communication ports for another one of the alarm units to power all of the alarm units from the power adapter and to communicate data between the plural alarm units,
wherein the plural alarm units are programmed to generate the detectable signal responsive to a system breach detected by any of the plural alarm units.

2. The alarm monitoring system according to claim 1 wherein each alarm unit further comprises an arming circuit operable to change the alarm unit between an armed state and an unarmed state.

3. The alarm monitoring system according to claim 2 wherein the arming circuit comprises one of a key actuator, an RFID circuit, and a keypad.

4. The alarm monitoring system according to claim 2 wherein the arming circuit comprises an electronic key including a programmable memory circuit.

5. The alarm monitoring system according to claim 2 wherein the arming circuit of each alarm unit is adapted to change all of the plural alarm units between the armed state and the unarmed state.

6. The alarm monitoring system according to claim 1 wherein each programmed controller circuit is programmed to perform a dual check of each sensor to generate the detectable signal.

7. The alarm monitoring system according to claim 1 wherein the generated detectable signal is an audible signal.

8. The alarm monitoring system according to claim 1 wherein the generated detectable signal is a visual signal.

9. The alarm monitoring system according to claim 8 wherein each alarm unit comprises a visual indicator associated with each sensor port and the visual signal comprises illuminating the visual indicator associated with the sensor detecting the breach.

10. The alarm monitoring system according to claim 1 wherein the power supply of each alarm unit comprises a rechargeable battery backup circuit.

11. The alarm monitoring system according to claim 1 wherein the system breach that causes the generation of the detectable signal is a movement of the portable article outside of a prescribed area.

12. The alarm monitoring system according to claim 1 wherein the system breach that causes the generation of the detectable signal is a separation of a sensor from the portable article.

13. The alarm monitoring system according to claim 1 wherein the system breach that causes the generation of the detectable signal further comprises a reconfiguration of a part of the monitoring system.

14. The alarm monitoring system according to claim 1 further comprising a signal generator on the portable article and a sensor comprise a signal receiver and a system breach results from the signal generator and signal receiver either: a) establishing communication; or b) having a communication interrupted.

15. The alarm monitoring system according to claim 1 wherein the generated detectable signal is communicated to a remote device.

16. The alarm monitoring system according to claim 2 wherein the detectable signal is generated if one of a key, RFID device or smart key remains engaged with the arming circuit.

17. An alarm monitoring system comprising:
first and second alarm units, each comprising a housing having a plurality of sensor ports, each for connection to a sensor for sensing a breach of a portable article, a power input, first and second communication ports, a programmed controller circuit connected to the sensor ports, a communications circuit connected between the programmed controller circuit and the first and second communication ports, a power supply connected to the power input for powering the alarm unit, and the power input being connected to the first and second communication ports, and the programmed control circuit includes an alarm function to generate a detectable signal detectable signal as an incident of a system breach;
a power adapter operatively connected to the power input for the first alarm unit; and
a plurality of one or more cables connecting one of the first and second communication ports of the first alarm unit to one of the first and second communication ports for the second alarm unit to power both of the alarm units from the power adapter and to communicate data between the alarm units,
wherein the first and second alarm units are programmed to generate the detectable signal responsive to a system breach detected by either of the alarm units.

18. The alarm monitoring system according to claim 17 wherein each alarm unit further comprises an arming circuit operable to change the alarm unit between an armed state and an unarmed state, and wherein the arming circuit of each alarm unit is adapted to change both alarm units between the armed state and the unarmed state.

19. An alarm monitoring system comprising:
a plurality of alarm units, each alarm unit comprising a housing having a plurality of sensor ports, each for connection to a sensor for sensing a breach of a portable article, a power input, first and second communication ports, a programmed controller circuit connected to the sensor ports, a communications circuit connected between the programmed controller circuit and the first and second communication ports, a power supply connected to the power input for powering the alarm unit, and the power input being connected to the first and second communication ports, and the programmed control circuit includes an alarm function to generate a detectable signal detectable signal as an incident of a system breach;
a power adapter operatively connected to the power input for one of the alarm units; and
a plurality of cables connecting the plural alarm units in series, each cable for connecting one of the first and second communication ports of one of the alarm units to one of the first and second communication ports for another one of the alarm units to power all of the alarm units from the power adapter and to communicate data between the plural alarm units,
wherein the plural alarm units are programmed to generate the detectable signal responsive to a system breach detected by any of the plural alarm units.

20. The alarm monitoring system according to claim 19 wherein each alarm unit further comprises an arming circuit operable to change the alarm unit between an armed state and an unarmed state, and wherein the arming circuit of each alarm unit is adapted to change both alarm units between the armed state and the unarmed state.
